(19) United States
(12) Patent Application Publication
(10) Pub. No.: US 2023/0276848 A1
(43) Pub. Date: Sep. 7, 2023

(54) APPARATUS FOR A VAPORIZER DEVICE

(71) Applicant: Jupiter Research, LLC, Phoenix, AZ (US)

(72) Inventors: San Li, Chandler, AZ (US); Jordan Walker, Phoenix, AZ (US); Mark Scatterday, Scottsdale, AZ (US); Noel Fitzpatrick, Miami, FL (US)

(21) Appl. No.: 18/067,297

(22) Filed: Dec. 16, 2022

Related U.S. Application Data
(60) Provisional application No. 63/316,159, filed on Mar. 3, 2022.

(51) Int. Cl. A24F 40/42; A24F 40/10; A24F 40/48; B03C 5/00

(52) U.S. Cl. CPC A24F 40/42; A24F 40/10; A24F 40/48; B03C 5/00

(57) ABSTRACT

The disclosed cartridge for use in a vaporizer device may include a housing and a porous body comprising a first surface and a second surface opposite the first surface, wherein the porous body is configured to wick a vaporizable filtrate. The cartridge may also include a reservoir in fluid communication with the porous body and configured to hold a vaporizable liquid. In addition, the cartridge may include a filter disposed between the porous body and the reservoir and configured to filter the vaporizable liquid to form the vaporizable filtrate. The cartridge may further include a heating element and an airflow path. The heating elemnet may be positioned immediately adjacent to the second surface and configured to apply heat to the porous body and the airflow path may be configured to draw vapor from the porous body.

### CROSS REFERENCE TO RELATED APPLICATIONS

This application claims priority to U.S. provisional patent application entitled “APPARATUS FOR A VAPORIZER DEVICE,” Ser. No. 63/316,159, filed Mar. 3, 2022, the disclosure of which is hereby incorporated entirely herein by reference.

### BACKGROUND

### State of the Art

“Vape” devices and heat-not-burn (HNB) devices (collectively, “vaporizer devices”) present an alternative to smoking and work by vaporizing a consumable vaporizable product, e.g., liquid or extract, by heating the vaporizable product at a lower temperature than an open flame so that a user can inhale the vaporizable product in vapor form, rather than smoke.

A conventional cartridge of a vaporizer device typically has a reservoir for holding the vaporizable product, a wick capable of soaking up the vaporizable product, and a heated coil, in contact with the wick. A current is typically passed through the coil, heating the wick, and vaporizing the vaporizable product. However, a conventional cartridge is not configured to make the best or most effective use of various chemical and physical properties of the vaporizable product. Because different vaporizable products have different chemical properties and physical properties, e.g., vapor pressure, a conventional cartridge is prone to producing low-quality vapor and inconsistent flavor profiles. Furthermore, a conventional cartridge commonly leaves a residue in the reservoir, thereby further tainting the vapor.

Accordingly, what is needed is a cartridge that efficiently releases various active ingredients contained in a wide range of vaporizable products so that a user can be provided with high-quality vapor, consistent flavor profiles, and improved sensory experiences over the lifetime of the cartridge.

### SUMMARY

The disclosed cartridge for use in a vaporizer device may comprise a housing and a porous body comprising a first surface and a second surface opposite the first surface, wherein the porous body is configured to wick a vaporizable filtrate. The cartridge may also comprise a reservoir in fluid communication with the porous body and configured to hold a vaporizable liquid. In addition, the cartridge may comprise a filter disposed between the porous body and the reservoir and configured to filter the vaporizable liquid to form the vaporizable filtrate. The cartridge may further comprise a heating element and an airflow path. The heating element may be positioned immediately adjacent to the second surface and configured to apply heat to the porous body and the airflow path may be configured to draw vapor from the porous block.

### BRIEF DESCRIPTION OF THE DRAWINGS

A more complete understanding of the present technology may be derived by referring to the detailed description when considered in connection with the following illustrative figure.

FIG. 1 representatively illustrates a cartridge in accordance with a first embodiment of the present technology; and

FIG. 2 representatively illustrates a cartridge in accordance with a second embodiment of the present technology.

### DETAILED DESCRIPTION OF EMBODIMENTS OF THE INVENTION

The subject technology may be described in terms of functional components. Such functional components may be realized by any number of components configured to perform the specified functions and achieve the various results. For example, the subject technology may employ various, batteries, coils, filters, heating elements, inlets, outlets, porous bodies, porous blocks, reservoirs, vaporizable liquids, vaporizable filtrates, and the like, which may carry out a variety of functions. In addition, the present technology may be practiced in conjunction with any one of various vaporizer devices, and the cartridge described herein is merely one exemplary application for the technology.

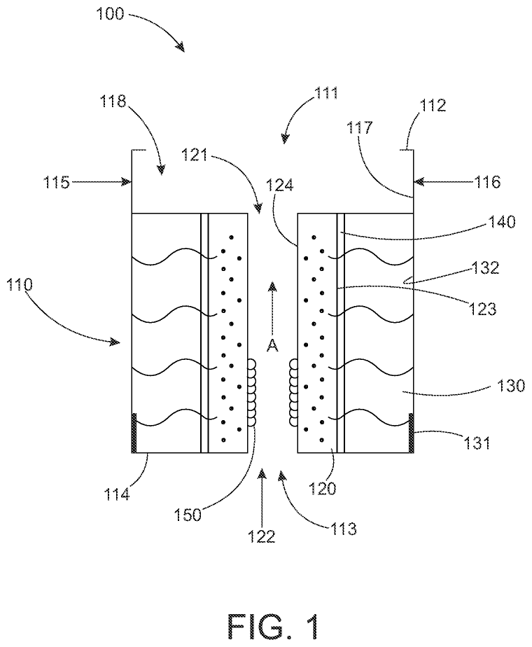

Referring to FIG. 1, in various embodiments, a cartridge 100 adapted to be inserted into a housing (not shown) of a “vape” device, IQOS device, or heat-not-burn (“HNB”) device (the “vaporizer device” (not shown)) may be capable of filtering a vaporizable liquid to form a vaporizable filtrate and producing vapor from the vaporizable filtrate. The cartridge 100 may comprise a housing 110, a porous body 120, a reservoir 130, a filter 140, and a heating element 150.

The housing 110 may contain or hold the porous body 120, reservoir 130, filter 140, and the heating element 150. The housing 110 may comprise an open first end 111 terminating in a first peripheral edge 112, an open second end 113 opposite the open first end 111 terminating in a second peripheral edge 114, and a sidewall 115 extending from the first peripheral edge 112 to the second peripheral edge 114. The sidewall 115 comprises an outer surface 116 and an inner surface 117 defining a receptacle cavity 118 in the housing 110. The inner surface 117 may be configured to receivably engage the reservoir 130. In some embodiments, the housing 110 may further comprise a coupling component (not shown) located near the first peripheral edge 112, the second peripheral edge 114, or along the sidewall 115 that is configured to couple the porous body 120 to the inner surface 117 of the housing 110.

The porous body 120 may be configured to wick the vaporizable filtrate. In one embodiment, the porous body 120 may be positioned adjacent to the reservoir 130 and may comprise an open first end 121, an open second end 122 opposite the open first end 121. Additionally, the porous body 120 may comprise a first surface (outer surface 123) and a second surface (inner surface 124), which may define an airflow path A. The airflow path A may extend along a longitudinal axis of the porous body 120. The porous body 120 may comprise any suitable size or shape, such as a tubular-shaped body, a rectangular prism-shaped body, or a cube-shaped body.

The porous body 120 may be constructed from any suitable porous material, such as ceramic, cellulose, and the like. The porous material may have any suitable pore size and/or porosity and the pore size and/or porosity may be selected to allow certain compounds of the vaporizable filtrate to be vaporized by the heating element 150 while preventing certain unwanted compounds in the vaporizable filtrate from being vaporized by the heating element 150. In addition, the pore size and/or porosity may be selected based on the desired thermal conductivity of the porous body 120. As an example, a porous body with small-sized pores and a high porosity may have a higher thermal conductivity than a porous body with large-sized pores and a low porosity.

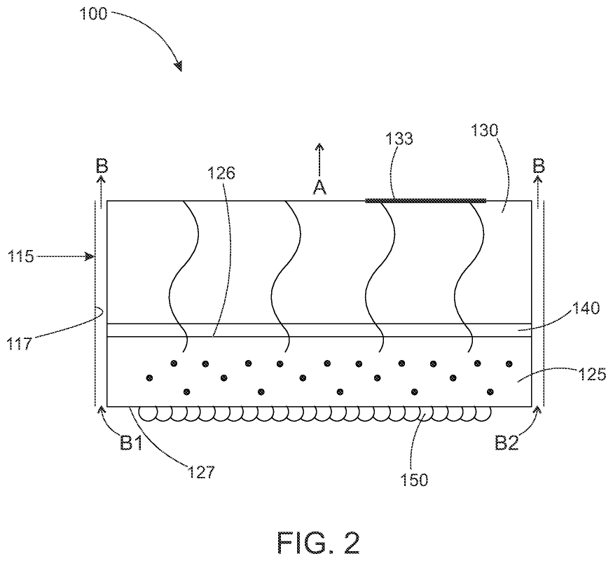

Modifications may be made to the porous body 120 without departing from the scope of the present invention. For example, instead of the porous body 120, the cartridge 100 may comprise a porous block 125, such as shown in FIG. 2. The porous block 125 may be positioned adjacent to the reservoir 130 and may comprise a first surface (top surface 126) and a second surface (bottom surface 127) and may be configured to wick the vaporizable filtrate.

The porous block 125 may be constructed from any suitable porous material, such as ceramic, cellulose, and the like. The porous material may have any suitable pore size and/or porosity and the pore size and/or porosity may be selected to allow certain compounds of the vaporizable filtrate to be vaporized by the heating element 150 while preventing certain unwanted compounds in the vaporizable filtrate from being vaporized by the heating element 150. In addition, the pore size and/or porosity may be selected based on the desired thermal conductivity of the porous block 125. For example, a porous block with small-sized pores and a high porosity may have a higher thermal conductivity than a porous body with large-sized pores and a low porosity. The porous block 125 may be disposed within the housing 110 of the cartridge 100 to form an airflow path B. The airflow path B may comprise a first section (gap B1) and a second section (gap B2) opposite the first gap B1. The first gap B1 and the second gap B2 may each be disposed between the porous block 125 and the inner surface 117 of the sidewall 115.

The reservoir 130 may be configured to hold a vaporizable liquid. For the purposes of this Application, “vaporizable liquid” means any suitable cannabis and/or tobacco concentrate, oil, and the like. In one embodiment, the reservoir 130 may be in fluid communication with the outer surface 123 of the porous body 120. The reservoir 130 may comprise an outer edge 132 that is flush with the inner surface 117 of the housing 110 when receivably engaged with the sidewall 115 of the cartridge 100, such as shown in FIG. 1. In another embodiment, the reservoir 130 may be in fluid communication with the top surface 126 of the porous block 125, such as shown in FIG. 2. The reservoir 130 may comprise any suitable shape, such as a tubular-shaped body, a rectangular prism-shaped body, or a cubic-shaped body. Additionally, the reservoir 130 may comprise any suitable volume. For example, in one embodiment, the reservoir 130 may hold up to 5 or 6 ml of the vaporizable liquid. Furthermore, the reservoir 130 may be constructed from any suitable material, such as glass, plastic, and the like.

In one embodiment, and in the case where the cartridge 100 comprises the porous body 120, a surface 131 of the reservoir 130 opposite the porous body 120 may be electrically charged. The surface 131 may be positioned immediately adjacent to the inner surface 117 of the housing 110. In this regard, the surface 131 may attract certain negatively charged and unwanted compounds and/or contaminants contained in the vaporizable liquid thereto and thus prevent said unwanted compounds and/or contaminants from moving towards the porous body 120, the heating element 150, or an area within the cartridge 100 where vaporization occurs. Similarly, in the case where the cartridge 100 comprises the porous block 125, a surface 133 of the reservoir 130 opposite the porous block 125 may be electrically charged. In this regard, the surface 133 may attract certain negatively charged and unwanted compounds and/or contaminants contained in the vaporizable liquid thereto and thus prevent said unwanted compounds and/or contaminants from moving towards the porous block 125, the heating element 150, or an area within the cartridge 100 where vaporization occurs.

The filter 140 may be configured to filter the vaporizable liquid to form the vaporizable filtrate, which may in turn be wicked by the porous body 120 or the porous block 125, as the case may be. Specifically, the filter 140 may allow certain compounds of the vaporizable liquid to pass through the filter 140 and prevent certain unwanted compounds of the vaporizable liquid from passing through the filter 140. In one embodiment, the filter 140 may be positioned immediately adjacent to the outer surface 123 of the porous body 120 and the reservoir 130, such that the filter 140 may be disposed therebetween. In another embodiment, the filter 140 may be positioned immediately adjacent to the top surface 126 of the porous block 125 and the reservoir 130, such that the filter 140 may be disposed therebetween.

The filter 140 may be constructed from any suitable filtration material, such as a wire mesh, a nylon monofilament mesh, a ceramic film, and the like. For example, the filter 140 may be constructed from a wire mesh having a size of 90 Microns. The 90 Micron wire mesh may be effective in preventing various lipid compounds contained in the vaporizable liquid from passing through the filter 140 to the porous body 120 or the porous block 125, as the case may be. In an alternative embodiment, the filter 140 may be constructed from a ceramic material. The ceramic material may be effective in preventing various chlorophyll and/or wax compounds contained in the vaporizable liquid from passing through the filter 140. In some embodiments, the filter 140 may be electrically charged. Specifically, the filter 140 may comprise a net positive charge so that the filter 140 may prevent certain negatively charged and unwanted compounds and/or contaminants contained in the vaporizable liquid from passing through the filter 140. Because flavor profiles and sensory experiences may be enhanced and/or modified according to the particular filtration material used in the cartridge 100, the cartridge 100 may efficiently release various active ingredients contained in a wide range of vaporizable liquids so that a user may be provided with high-quality vapor, consistent flavor profiles, and improved sensory experiences over the lifetime of the cartridge.

The heating element 150 may be configured to apply heat to the porous body 120 or the porous block 125, as the case may be. In one embodiment, the heating element 150 may be positioned immediately adjacent to with the inner surface 124 of the porous body 120 and may heat the porous body 120 to a temperature sufficient to vaporize the vaporizable filtrate. In another embodiment, the heating element 150 may be positioned immediately adjacent to the bottom surface 127 of the porous block 125 and may heat the porous block 125 to a temperature sufficient to vaporize the vaporizable filtrate. The heating element 150 may comprise any suitable resistive element, such as a coil, ribbon, strip of wire, wire mesh, or the like, that dissipates heat when an electric current flows through it. The heating element 150 may be constructed from a variety of suitable materials, such as copper, nickel, iron, stainless steel, or a combination thereof. The heating element 150 may have any suitable resistance as long as the heating element 150 dissipates enough heat to heat the vaporizable filtrate to a temperature sufficient to vaporize the vaporizable filtrate.

In operation, the cartridge 100 may be inserted into the housing (not shown) of the vaporizer device (not shown), and the vaporizer device (not shown) may be turned on so that a battery (not shown) may supply power to various components of the vaporizer device (not shown), including the heating element 150. Because the reservoir 130 may be in fluid communication with the porous body 120 or the porous block 125, the vaporizable liquid may pass through the filter 130 to the porous body 120 or the porous block 125, as the case may be. As the vaporizable liquid is passed through the filter 130, the porous body 120 or the porous block 125 may wick the resulting vaporizable filtrate. Because the heating element 150 may be in contact with the porous body 120 or the porous block 125, the generated heat may be transferred to the porous body 120 or the porous block 125, as the case may be. Accordingly, the heating element 150 may vaporize the vaporizable filtrate by heating the porous body 120 or the porous block 125 to a temperature sufficient to generate the vapor. Once the vapor is produced, it may mix with air drawn into the cartridge 100 via the second open end 113, and the resulting aerosol (vapor and airflow) may travel as an aerosol stream along an airflow path A or along an airflow path B where it may be expelled via the first open end 111 and inhaled through a mouthpiece (not shown) of the vaporizer device (not shown).

The particular implementations shown and described are illustrative of the technology and its best mode and are not intended to otherwise limit the scope of the present technology in any way. Indeed, for the sake of brevity, conventional manufacturing, connection, preparation, and other functional aspects of the apparatus may not be described in detail. Furthermore, the connections and points of contact shown in the figure is intended to represent an exemplary physical relationship between the various elements. Many alternative or additional functional relationships or physical connections may be present in a practical system.

In the foregoing description, the technology has been described with reference to specific embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the components and/or elements recited in any apparatus embodiment may be combined in a variety of permutations to produce substantially the same result as the present technology and are accordingly not limited to the specific configuration recited in the specific examples.

Benefits, other advantages, and solutions to problems have been described above with regard to particular embodiments. Any benefit, advantage, solution to problems or any element that may cause any particular benefit, advantage, or solution to occur or to become more pronounced, however, is not to be construed as a critical, required, or essential feature or component.

The terms “comprises,” “comprising,” or any variation thereof, are intended to reference a non-exclusive inclusion, such that a process, method, article, composition, or apparatus that comprises a list of elements does not include only those elements recited but may also include other elements not expressly listed or inherent to such process, method, article, composition, or apparatus. Other combinations and/or modifications of the above-described structures, arrangements, applications, proportions, elements, materials, or components used in the practice of the present technology, in addition to those not specifically recited, may be varied, or otherwise particularly adapted to specific environments, manufacturing specifications, design parameters or other operating requirements without departing from the general principles of the same.

The present technology has been described above with reference to an embodiment. However, changes and modifications may be made to the embodiment without departing from the scope of the present technology. These and other changes or modifications are intended to be included within the scope of the present technology.

1. A cartridge for use in a vaporizer device, comprising:
a housing;
a porous body comprising a first surface and a second surface opposite the first surface, wherein the porous body is configured to wick a vaporizable filtrate;
a reservoir in fluid communication with the porous body and capable of holding a vaporizable liquid;
a filter disposed between the porous body and the reservoir and configured to filter the vaporizable liquid to form the vaporizable filtrate; and
a heating element positioned immediately adjacent to the second surface and configured to apply heat to the porous body; and
an airflow path configured to draw vapor from the porous body.

2. The cartridge of claim 1, wherein the reservoir comprises an electrically charged surface positioned opposite the porous body and configured to draw contaminants contained in the vaporizable liquid away from the porous body.

3. The cartridge of claim 1, wherein the housing comprises:
an open first end terminating in a first peripheral edge;
an open second end opposite the open first end terminating in a second peripheral edge; and
a sidewall extending from the first peripheral edge to the second peripheral edge, wherein:
the sidewall comprises an outer surface and an inner surface defining a receptacle cavity in the housing; and
the inner surface is configured to receivably engage the reservoir.

4. The cartridge of claim 3, wherein:
the reservoir comprises an outer edge and the outer edge is flush with the inner surface of the housing when receivably engaged with the sidewall of the cartridge;
the porous body is positioned adjacent to the reservoir; and
the filter is positioned immediately adjacent to the first surface of the porous body and the reservoir, wherein the filter is disposed therebetween.

5. The cartridge of claim 1, wherein the filter comprises a wire mesh, a nylon monofilament mesh, or a ceramic film.

6. The cartridge of claim 1, wherein the filter comprises an electrically charged filter, and wherein the electrically charged filter is configured to prevent contaminants contained in the vaporizable liquid from passing through the electrically charged filter.

7. The cartridge of claim 5, wherein the size of the wire mesh is 90 microns.

8. The cartridge of claim 6, wherein the electrically charged filter comprises a net positive charge.

9. A cartridge for use in a vaporizer device, comprising:
a housing;
a porous block comprising a first surface and a second surface opposite the first surface, wherein the porous block is configured to wick a vaporizable filtrate;
a reservoir in fluid communication with the porous block and capable of holding a vaporizable liquid;
a filter disposed between the porous body and the reservoir and configured to filter the vaporizable liquid to form the vaporizable filtrate; and
a heating element positioned immediately adjacent to the second surface and configured to apply heat to the porous block; and
an airflow path configured to draw vapor from the porous block.

10. The cartridge of claim 9, wherein the reservoir comprises an electrically charged surface positioned opposite the porous block, and wherein the electrically charged surface is configured to draw contaminants contained in the vaporizable liquid away from the pourous block.

11. The cartridge of claim 9, wherein the housing comprises:
an open first end terminating in a first peripheral edge;
an open second end opposite the open first end terminating in a second peripheral edge; and
a sidewall extending from the first peripheral edge to the second peripheral edge, wherein:
the sidewall comprises an outer surface and an inner surface defining a receptacle cavity in the housing; and
the airflow path is formed between the inner surface and the porous block.

12. The cartridge of claim 11, wherein:
the reservoir comprises an outer edge and the outer edge and the inner surface of the housing form a gap therebetween;
the porous block is positioned adjacent to the reservoir; and
the filter is positioned immediately adjacent to the first surface of the porous block and the reservoir.

13. The cartridge of claim 9, wherein the filter comprises a wire mesh, a nylon monofilament mesh, or a ceramic film.

14. The cartridge of claim 9, wherein the filter comprises an electrically charged filter, and wherein the electrically charged filter is configured to prevent contaminants contained in the vaporizable liquid from passing through the electrically charged filter.

15. The cartridge of claim 13, wherein the size of the wire mesh is 90 microns.

16. The cartridge of claim 14, wherein the electrically charged filter comprises a net positive charge.
